(19) United States
(12) Patent Application Publication
(10) Pub. No.: US 2025/0181075 A1
(43) Pub. Date: Jun. 5, 2025

(54) Robot with Obstacle Navigation

(71) Applicant: Piaggio Fast Forward Inc., Boston, MA (US)

(72) Inventors: Gregory Stewart Lynn, Venice, CA (US); Tyson Phillips, Somerville, MA (US); Mackenzie Pierson, Seattle, WA (US); Jeffrey T. Schnapp, Cambridge, MA (US)

(21) Appl. No.: 18/967,118

(22) Filed: Dec. 3, 2024

Related U.S. Application Data
(60) Provisional application No. 63/605,899, filed on Dec. 4, 2023.

(51) Int. Cl. G05D 1/633; G05D 1/698

(52) U.S. Cl. CPC G05D 1/633; G05D 1/6985

(57) ABSTRACT

A method of operating a robot in a manner to avoid obstacles is disclosed. The robot is any type of following vehicle, configured to follow a leader. As the robot identifies a potential collision, specific actions are initiated to avoid such a collision while still following the leader, albeit not on a standard following path. Based on the following robot determining that the following robot is clear of the obstacle, the following robot will begin returning to the standard following position. As the robot returns to the standard following path, the specific action is completed and standard following continues. The robot may use various sensors to determine variables of the robot and obstacle, such as convergence velocity, collision distance, available space, and collision time.

### CROSS-REFERENCE TO RELATED APPLICATIONS

This application claims the benefit of U.S. Provisional Application No. 63/605,899, filed Dec. 4, 2023, entitled “Robot with Obstacle Navigation,” which is assigned to the assignee hereof, and the entire contents of which are hereby incorporated herein by reference for all purposes.

### TECHNICAL FIELD

The present invention relates to a robot capable of following a leader and avoiding obstacles each of whose location or trajectory intersects a standard following trajectory of the robot.

### BACKGROUND ART

Robots that are capable of following a leader are becoming commonplace in the art. In US Patent App. Pub. No. 2021/0208589 to Qi, a self-driving luggage is disclosed. The self-driving luggage has a central processing unit that is capable of entering a following mode.

In US. Patent App. Pub. No. 2021/0031769 to Matsumoto, a following target identification system is disclosed. The target identification system helps the robot keep a view on the following target.

For a robot configured to strictly follow the path of a leader, to avoid collision with an object intersecting with the robot's trajectory along this path, the robot may stop and wait until the object has cleared from the path, or speed up or slow down. A disadvantage of stopping or slowing down for collision avoidance is the risk of losing the leader while the robot is stopped. A disadvantage of speeding up for object collision avoidance is possible collision with the leader.

### SUMMARY

In accordance with some embodiments of the invention, a method of operating a robot is disclosed. The robot is configured to follow a trajectory of a leader, in a manner to avoid an obstacle, the obstacle having a trajectory that intersects with a standard trajectory of the robot. The method comprises:
detecting the obstacle using a set of sensors of the robot;
determining, by a controller of the robot coupled to the set of sensors, using data from the set of sensors, a set of parameters characterizing motion of the obstacle relative to the robot; and
evaluating, by the controller, a risk of a collision between the obstacle and the robot;
under a circumstance wherein the evaluated risk exceeds a predetermined threshold, causing, by the controller, implementation of an obstacle avoidance protocol; and
after implementation of the obstacle avoidance protocol, causing, by the controller, the robot to return to following the trajectory of the leader.

Optionally, the obstacle avoidance protocol includes causing the robot to have a lateral offset from the standard trajectory. Also optionally, the obstacle avoidance protocol is selected from the group consisting of a cross and a duck.

Optionally, evaluating risk of a collision includes evaluating a collision time and wherein the predetermined threshold is a value of the collision time.

In some embodiments, implementation of the obstacle avoidance protocol is deemed completed based on the collision time being above a return threshold. Optionally, the return threshold of the duck is different from the return threshold of the cross.

Also optionally, the method further includes evaluating, by the controller, (i) a convergence speed of the obstacle and the robot and (ii) a distance of the robot from the leader; and calculating an obstacle navigation decision factor based on the convergence speed and the distance.

In some embodiments, the obstacle navigation decision factor is compared to a decision threshold to determine a type of obstacle avoidance protocol to be implemented by the robot. The type of obstacle avoidance protocol may be selected from the group consisting of a cross and a duck.

Also optionally, the robot performs the method autonomously.

In accordance with some embodiments of the invention, a robot is disclosed. The robot is configured to follow a trajectory of a leader in a manner to avoid an obstacle. The robot includes a body including a set of sensors and a drive mechanism, and a controller disposed in the body and coupled to the set of sensors and the drive mechanism.

The controller may be configured to detect the obstacle using the set of sensors, to determine, using data from the set of sensors, a set of parameters characterizing motion of the obstacle relative to the robot, and to evaluate a risk of a collision between the obstacle and the robot. The controller is also configured to cause, under a circumstance wherein the evaluated risk exceeds a predetermined threshold, implementation of an obstacle avoidance protocol, and to cause, after implementation of the obstacle avoidance protocol, the robot to return to following the trajectory of the leader.

Optionally, to cause implementation of the obstacle avoidance protocol the controller may be configured to cause the robot to have a lateral offset from the standard trajectory. Also optionally, the obstacle avoidance protocol is selected from the group consisting of a cross and a duck.

Optionally, to evaluate risk of a collision the controller may be configured to evaluate a collision time, wherein the predetermined threshold is a value of the collision time.

In some embodiments, the controller may be configured to determine that implementation of the obstacle avoidance protocol is complete based on the collision time being above a return threshold. Optionally, the return threshold of the duck is different from the return threshold of the cross.

Also optionally, the controller may be further configured to evaluate (i) a convergence speed of the obstacle and the robot and (ii) a distance from the leader; and to calculate an obstacle navigation decision factor based on the convergence speed and the distance.

In some embodiments, the controller may be configured to compare the obstacle navigation decision factor to a decision threshold to determine a type of obstacle avoidance protocol to be implemented by the robot. The type of obstacle avoidance protocol may be selected from the group consisting of a cross and a duck.

### BRIEF DESCRIPTION OF THE DRAWINGS

The foregoing features of embodiments will be more readily understood by reference to the following detailed description, taken with reference to the accompanying drawings.

FIG. 1A is a diagram illustrating, from a top view, of a robot 103 following a leader 101 and avoiding an obstacle 102, in accordance with the invention.

FIG. 1B is a diagram of an angle between a velocity of robot 103 and a velocity of obstacle 102.

FIG. 2 is a diagram, from a top view, of robot 103 initiating an obstacle avoidance protocol in accordance with the invention.

FIG. 3 is a diagram, from a top view, of robot 103 returning to standard following procedure after having executed an obstacle avoidance protocol in accordance with the invention.

FIG. 4 is a flowchart of a robot's logic in initiating and commencing an obstacle avoidance protocol in accordance with the invention.

FIG. 5 is a diagram, from a top view, showing an obstacle 502 moving in a non-perpendicular trajectory relative to a path 511 of a leader 501 in accordance with the invention.

FIG. 6 is a diagram, from a top view, showing an obstacle 602 moving in a non-perpendicular trajectory relative to a path 611 of a leader 601 in accordance with the invention.

FIG. 7 is a diagram, from a top view, showing a robot 703 following a leader 701 in accordance with the invention along a curved trajectory 711, and the robot 703 avoiding, in accordance with the invention, an obstacle 702 that intersects the leader's trajectory 711.

### DETAILED DESCRIPTION OF SPECIFIC EMBODIMENTS

Definitions. As used in this description and the accompanying claims, the following terms shall have the meanings indicated, unless the context otherwise requires:

A “set” has at least one member.

An “Obstacle Navigation Trigger Moment” is a moment when a robot identifies a potential collision with an obstacle and initiates specific actions to avoid such potential collision.

A “Return Trigger Moment” is a moment when the robot is clear of all obstacles and initiates returning to normal following behavior.

An “End of Behavior Moment” is a moment where the robot has returned to normal following behavior.

A “Convergence Velocity” is a relative speed of a robot and an obstacle, e.g., calculated as a function of the linear velocity of both objects and their relative angle.

A “Collision Distance” is a distance between a robot and an obstacle.

An “Available Space” is a distance between a robot and its leader.

A “Collision Time” is a perceived time until there is a collision between a follower and an obstacle, e.g., calculated as the collision distance divided by the convergence velocity.

A “Lateral Offset” is a perpendicular distance from a typical path of travel during normal following behavior to an actual path travelled by a robot. The lateral offset can be positive, meaning the distance is away from an oncoming obstacle or negative, meaning the distance is toward the oncoming obstacle.

A “Following Distance” is a distance along a leader's path between the leader and a follower. The follower can be a robot. The following distance may have a positive or negative change, for example, in the presence of an obstacle. A positive change in following distance is further away from the leader and a negative change in following distance is toward the leader.

A set of tasks are “calculated continuously” if a controller performs the task at a regular interval, the interval being less than 1 second.

A robot “follows a trajectory of a leader” if the robot moves along a path defined generally (albeit not necessarily precisely) by the trajectory.

A robot “encounters” an obstacle in a path of the robot when there is a reasonable likelihood that the robot will experience a collision with the obstacle unless the robot adopts a protocol to avoid such a collision.

A “robot” is a self-powered vehicle having a motorized drive, a controller coupled to the motorized drive, and a set of sensors coupled to the controller, so as to support autonomous motion by the vehicle.

A robot is in a “collision” with an obstacle when the robot physically touches the obstacle or comes within a predefined threshold distance of the obstacle. The threshold distance may optionally be a function of a relative speed of the robot in relation to the obstacle.

A “standard trajectory” of a robot is a trajectory of the robot that is followed if an obstacle is not encountered by the robot.

An “obstacle avoidance protocol” of a robot is a movement of the robot performed to avoid an obstacle and that deviates from the standard trajectory.

A robot performs a “cross” when the robot makes an evasive maneuver that passes an obstacle's trajectory in front of the obstacle.

A robot performs a “duck” when the robot makes an evasive maneuver that passes an obstacle's trajectory behind the obstacle.

Standard path following by an autonomous robot suggests that a device, which is following a human operator, will attempt to stay on the path that the human operator has already travelled. In standard path following, in order to stay on the path of the human operator, a robot may stop and wait for an obstacle to pass. However, during the waiting period the stopped robot may lose the human leader. In contrast to this stop and wait behavior, humans who are following another person quite naturally dissociate themselves from the leader's path for a short period of time in order to adjust to changing conditions in their environment. This behavior is clear when a potential collision with an obstacle is detected and the follower makes one or more adjustments to avoid collision with the obstacle while still maintaining a following relationship with the leader.

Motion capture studies demonstrate that humans do not engage in simple path following but rather perform on-going adjustments in trajectory as they navigate individual and sequential turns. These adjustments are subtle, consistent, and predictable. They suggest that simple path following sometimes is insufficient and may be enhanced by means of subtle but significant variations in following behavior that render a following device's movements more human-like. Navigating a diverse array of spaces in ways that are intuitive to humans is helpful to a following device's success, not only from the standpoint of following a leader but also that of inspiring trust in bystanders.

Navigating obstacles is a common event that pedestrians encounter when going about their day. Obstacles can approach from various angles, at various speeds, and many range in size. The way a person navigates specific obstacles is subtle but common and consistent across human behavior. In pedestrian etiquette, it is desirable to limit collisions and travel efficiently (e.g., along a most efficient path) to a destination. This often calls for a follower to deviate from the follower's current path of travel and subsequently to decide how to return to the normal path of travel. Following devices should thusly act in a similar manner, navigating around their environment so as to try to reduce (or even minimize) disruptions while still maintaining a following relationship with their leader(s).

A following device that mimics human behavior and deviates from the path of the leader will operate in a more predictable and intuitive manner, both for the user and for others interacting with or viewing the following device, than will a prior art following device that stops and waits for obstacles to pass in order to avoid such deviation. Such intuitive behavior may result in fewer collisions, fewer hindrances, and ultimately better following of a leader than with previous devices. Persons in a vicinity of the following device may not alter their behaviors because of the presence of the following device (or alter their behaviors less than needed by the presence of other devices), thus creating a safer and more comfortable experience for all involved. The more the device's behaviors reflect human behaviors, the more trust users and bystanders will have in these devices as they operate in public. Imagine someone who walks down a sidewalk and does not adjust their trajectory for others versus someone who does adjust their trajectory to make room for others.

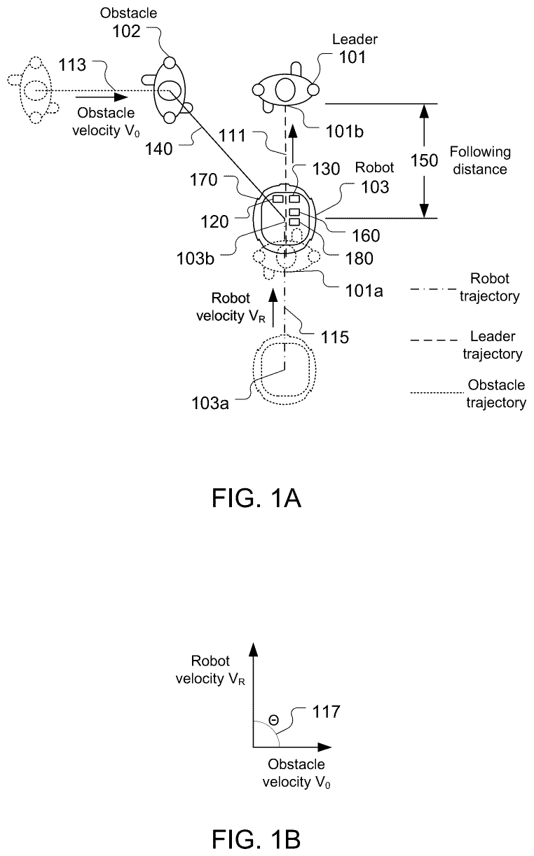

FIG. 1A is a diagram illustrating, from a top view, a robot 103 following a leader 101 and avoiding an obstacle 102, in accordance with the invention. In the embodiment of FIG. 1A, leader 101 is represented as a human. In other embodiments, the leader is an autonomous robot, a driven robot, an animal, a projection, or anything else capable of leading the robot 103. At a first time, leader 101 is at position 101a of a leader's trajectory 111 such that in the representation of FIG. 1A, at a second time that is after the first time, the leader 101 (e.g., a back of the leader 101 as shown) is at a position 101b. In FIG. 1A, the leader 101, the obstacle 102, and the robot 103 are shown in solid lines for present locations of the leader 101, the obstacle 102, and the robot 103. The leader 101, the obstacle 102, and the robot 103 are shown in dotted lines for previous locations of the leader 101, the obstacle 102, and the robot 103.

Robot 103 is an autonomous following robot, configured to autonomously follow the leader's trajectory 111. In some embodiments, the robot 103 follows the leader 101 with hysteresis dynamics. Hysteresis dynamics are following with generally understood social dynamics such as following from a longer distance when moving faster. The robot 103 can follow the leader 101 through a pairing device 120 (e.g., a short-range wireless protocol radio (e.g., a BLUETOOTH® radio) of the leader 101 and/or through one or more sensors 130 (e.g., a short-range wireless protocol radio, and/or one or more cameras and/or one or more other sensors (e.g., one or more radar sensors)) of the robot 103 that can identify and track the leader 101. If an avoidance protocol has not been initiated, then the robot 103 follows the leader 101 on a standard following path (i.e., a path that mimics the trajectory 111) from a position 103a at the first time to a position 103b at the second time.

Obstacle 102 is any obstacle having a trajectory that will intersect with the robot's trajectory 111. In various embodiments, the obstacle 102 is a human, an autonomous robot, a driven robot, an animal, or another object.

As shown in FIG. 1A, obstacle 102 is moving from left to right along trajectory 113. Obstacle 102 moves with a velocity V₀ in that direction. Robot 103 is moving up the page along a trajectory 115, at a velocity of V_{R}. Referring also to FIG. 1B, An angle 117 the two velocities V₀, V_{R} form is θ, also herein referred to as the angle of approach. In this example, the angle θ is about 90°, but this is an example only, and other values of the angle θ are possible. In at least some embodiments, a set of sensors (comprising one or more sensors) of the robot 103 determines the variables, V₀, V_{R}, and θ and, from those variables, the convergence velocity V_{C} from the following equation:

$${V}_{C} = \sqrt{{V}_{R}^{2} + {V}_{O}^{2} - 2 {V}_{R} {V}_{O} cos θ} \qquad ( 1 )$$

The variables V₀, V_{R}, and θ, and/or the convergence velocity V_{C} may comprise parameters characterizing motion of the obstacle 102 relative to the robot 103.

In some embodiments, the robot 103 is configured to determine autonomously each of these variables. A controller 160 within a body 170 of the robot 103 may be capable of making such determinations. In at least some embodiments, robot 103 has radar to determine the velocity of obstacle 102. In at least some embodiments, robot 103 has a camera to determine the velocity of obstacle 102. In at least some embodiments, robot 103 has one or more other mechanisms (e.g., sensors) for determining the obstacle's velocity.

After determining the convergence velocity V_{C}, the robot 103 can determine the collision time, e.g., by dividing a distance 140 to the obstacle 102 by the convergence velocity V_{C}. That is,

$${T}_{C} = \frac{{D}_{ob}}{{V}_{C}} \qquad ( 2 )$$

where D_{ob} is the distance 140 between robot 103 and obstacle 102, and V_{C} is the convergence velocity. In some embodiments, robot 103 determines the distance to obstacle 102 through a radar. In various embodiments, the radar is the same radar used to track the leader 101. In other embodiments, the robot 103 has a separate radar, or other sensor system, to watch for obstacles.

As shown in FIG. 1A, the robot 103 follows the leader 101 at a standard lateral offset and a standard following distance 150. The controller 160 may control a drive mechanism 180 (that is configured to propel and turn the robot 103) to control movement of the robot 103 to follow the leader 101 and to perform collision avoidance maneuvers as discussed herein. In the embodiment of FIG. 1A, the robot 103 is not offset at all (although the trajectory 115 is shown just offset from the trajectory 111 in order to show the overlap in the trajectories 111, 115); however, in various embodiments the robot 103 would be offset. For example, robot 103 can be programmed to heel (staying to one side of, and possibly slightly behind, the leader 101) while following leader 101. The standard following distance 150 of robot 103 behind the leader changes based on the speed of the leader 101, among other settings, which may be adjusted by an operator of robot 103.

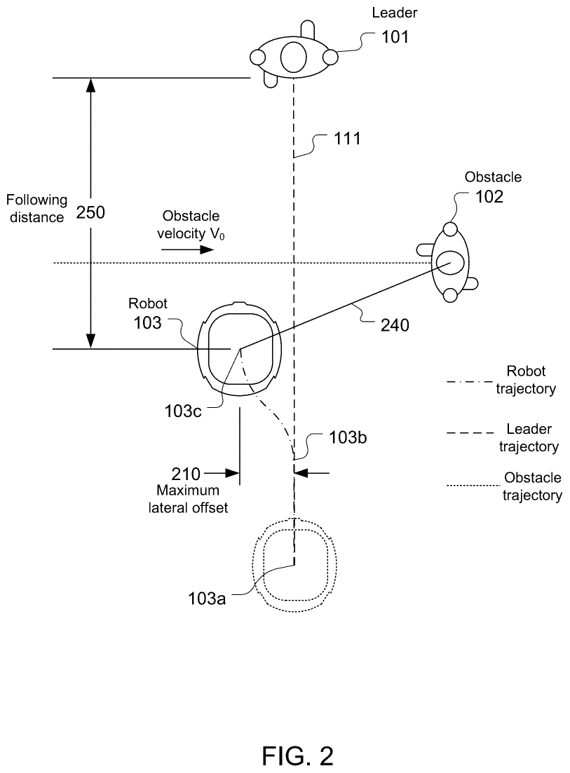

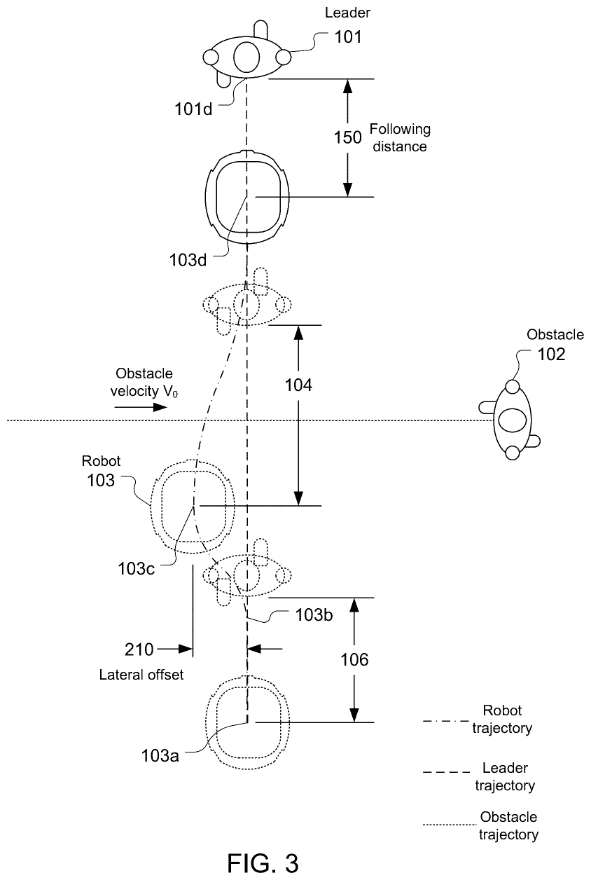

FIG. 2 is a diagram of robot 103 initiating an obstacle avoidance protocol. As robot 103 progressed from position 103b to 103c, robot 103 determined that a collision with obstacle 102 had a large enough potential to occur, that specific evasive maneuvers should be taken. In some embodiments, the robot 103 repeatedly evaluates the risk of a collision between the obstacle 102 and the robot 103. If the robot 103 determines that the obstacle 102 is an imminent threat to cause a collision or encounter with the robot 103, then the robot 103 may decide which type of action the robot 103 will take to avoid the obstacle. The robot 103 may be configured to perform, and may perform, any of a variety of options for avoiding a collision including, but not limited to, a crossing behavior and a ducking behavior, also referred to herein as performing a cross and performing a duck. The crossing behavior may be performed based on the robot 103 determining that the robot 103 should make an evasive maneuver off its normal course of action to pass in front of the obstacle 102 to avoid colliding with the obstacle 102. The robot 103 passes in front of the obstacle 102 by crossing a trajectory of the obstacle 102 at a crossover point before the obstacle 102 reaches the crossover point. The robot 103 may determine to move in any of a variety of directions to avoid collision. For example, the robot 103 may determine to move in the same direction as the obstacle 102 in addition to a direction of movement of the leader 101, or to move in a direction transverse to the direction of movement of the leader 101, which is at least partially in a direction of movement of the obstacle 102, in addition to a direction of movement of the leader 101, or to move in another direction that is at least partially in a direction of movement of the obstacle 102. The ducking behavior may be performed based on the robot 103 determining that the robot 103 should make an evasive maneuver off its normal course of action to pass behind the obstacle 102 to avoid colliding with the obstacle 102. The robot 103 passes behind the obstacle 102 by crossing a trajectory of the obstacle 102 at a crossover point (see FIG. 3 and corresponding discussion) after the obstacle 102 has passed through the crossover point. The robot 103 may determine to move in any of a variety of directions to avoid collision. For example, the robot 103 may determine to move in the opposite direction as the obstacle 102 in addition to a direction of movement of the leader 101, or to move in a direction transverse to the direction of movement of the leader 101, which is at least partially in a direction opposite of the direction of movement of the obstacle 102, in addition to a direction of movement of the leader 101, or to move in another direction that is at least partially opposite the direction of movement of the obstacle 102. During the crossing behavior, robot 103 passes in front of the obstacle whereas during the ducking behavior, robot 103 passes behind obstacle 102. In some embodiments, the direction of the obstacle 102 is determined by converting the velocity of the obstacle 102 into two vectors. One vector is parallel with the movement of the robot 103 and the other vector is perpendicular with the movement of the robot 103. The velocity perpendicular to the robot's movement determines the direction of the obstacle 102. In other embodiments, one or more of various methods of determining the direction of the obstacle 102 are used as would be appreciated by one having ordinary skill in the art.

As shown in FIG. 2, robot 103 performed a duck. The duck caused robot 103 to change its lateral offset relative to leader 101 from no lateral offset to a non-zero lateral offset 210 shown as a difference in lateral position from a position 103c compared to position 103b relative to the trajectory 111 of the leader 101. A distance 240 separates the robot 103 from the obstacle 102 at the instant shown in FIG. 2. Additionally, the duck caused the robot 103 to change its following distance behind leader 101 from the distance 150 to a distance 250, that is greater than the distance 150. In other embodiments, robot 103 only changes its lateral offset. In at least some embodiments, a change in lateral offset is proportional to a change in following distance.

FIG. 3 is a diagram of robot 103 returning to a standard following procedure after having executed an obstacle avoidance protocol. As shown in FIG. 3, robot 103 has returned to the standard following distance 150 and the standard lateral offset (e.g., zero offset) at position 103d when leader 101 is at position 101d and obstacle 102 has been avoided. FIG. 3 shows a following distance 104 at a time of a return (to standard following) trigger, the following distance 150 at the end of the behavior (here, a duck), and a following distance 106 at a time of a behavior (here, a duck) trigger. As shown, the distance 106 when the behavior is triggered is the same as the distance 150 at the end of the behavior, signaling that the robot 103 has returned to normal following behavior. The following distance 104 at the return trigger is longer than the distance 150 corresponding to normal following behavior. This extra distance between the robot 103 and the leader 101 during the behavior allows the robot 103 more space to perform a maneuver to avoid colliding with the obstacle 102. In some embodiments, the robot 103 does not change the distance it follows the leader 101 during an avoidance protocol. In some embodiments, the distance 106 is used to determine which avoidance protocol to use.

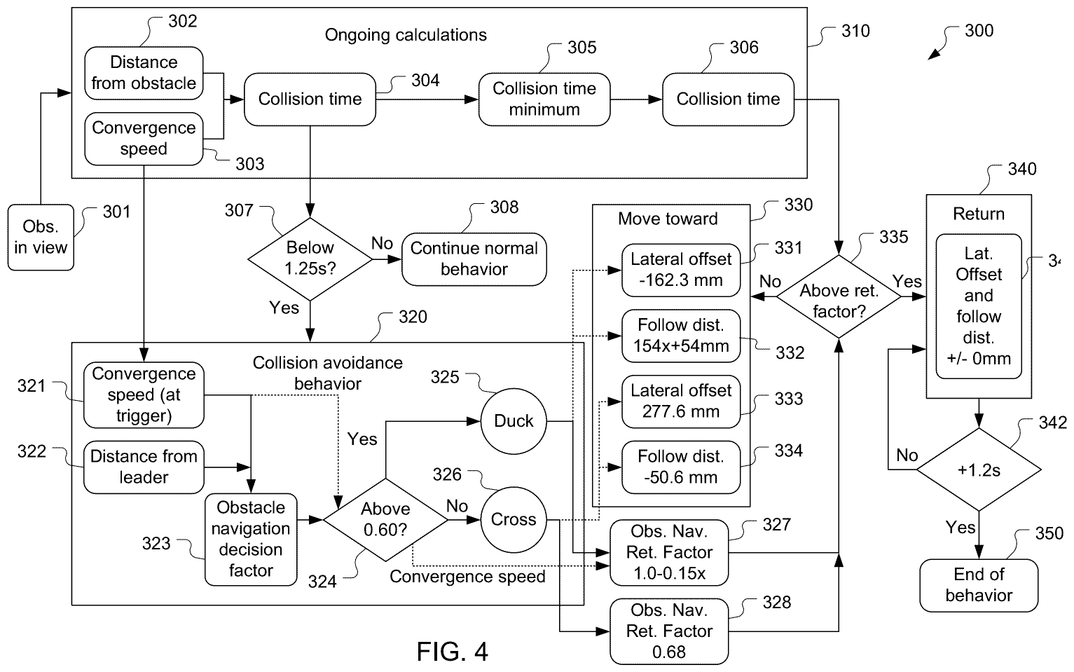

FIG. 4 is a flowchart of obstacle avoidance logic 300 for initiating and performing an obstacle avoidance protocol in accordance with the invention. The logic 300 may be configured to implement stages of operation as shown. The stages are an example, and one or more stages may be added, removed, or rearranged relative to the stages shown in FIG. 4. The obstacle avoidance protocol begins with the robot detecting an obstacle 301. The robot performs a set of calculations 310 that are calculated in an ongoing (e.g., periodic) manner. The calculations 310 include determining a distance 302 from the obstacle 301 to the robot and the obstacle's convergence speed 303. In some embodiments, the convergence speed may be calculated using the obstacle's velocity in the robot's reference frame. In other embodiments, the convergence speed 303 may be calculated using the velocities of the robot and the obstacle 301. From the distance 302 from the obstacle 301 and the convergence speed 303, a collision time 304 is also calculated. A typical robot is capable of processing these calculations 20 to 200 times per second.

The robot may calculate and monitor a collision time 304 and compare the collision time 304 with a collision time minimum 305 (i.e., a threshold collision time). The collision time minimum 305 may be reached as the obstacle avoidance protocol is executed. If so, then a collision avoidance behavior is performed as discussed with respect to stages 324-326, and a collision time 306 will eventually increase. The collision time 306 is monitored and if the collision time 306 exceeds a return factor, as discussed further below, then execution of the logic 300 will cause a return to normal operation, e.g., following at the standard distance 150.

The collision time 304 is monitored and compared 307 to a threshold collision time to determine if there is an imminent potential collision. If the collision time 304 is above the threshold collision time, then the robot moves to stage 308 and continues with normal behavior. If the collision time 304 is below the threshold collision time, then the robot will activate a collision avoidance behavior 320. In the example of FIG. 4, the threshold collision time is 1.25 seconds, but other values of the threshold collision time may be used. The value of the threshold collision time may depend on or more factors such as user preference, speed of vehicle, frequency of obstacles, purpose of use, and/or one or more other factors appreciated by one skilled in the art. In some embodiments, the threshold collision time is a function of a variable. The collision time meeting the threshold is also referred to as the “obstacle navigation trigger” moment or the “collision avoidance trigger” moment. In response to the collision time 304 being less than the threshold collision time, a convergence speed 321 and a distance 322 from the leader are calculated. The distance 322 from the leader, also referred to as the available space, is a direct measurement from the leader to the robot. This may or may not be the same as the following distance, which is the distance, along the following path, by which the robot trails the leader. Using the convergence speed 321 and the distance 322 from the leader, the robot calculates an obstacle navigation decision factor 323. In some embodiments, the obstacle navigation decision factor 323 is determined by dividing the distance 322 from the leader (the available space) by the convergence speed 321. The robot determines, at stage 324, whether the obstacle navigation decision factor 323 is above or below a threshold. If the obstacle navigation decision factor 323 is above the threshold (e.g., 0.60 in the example shown in FIG. 4), then the robot will determine to perform a duck 325, and otherwise will determine to perform a cross 326.

Guidance box 330 shows the guidance given to the robot to perform the duck 325 or the cross 326. For the cross 326, the robot actuates one or more appropriate drive mechanisms to move the robot from a present lateral offset and following distance (e.g., zero lateral offset and the standard following distance) toward having a cross lateral offset 333 and a cross following distance 334. For a duck 325, the robot actuates one or more appropriate drive mechanisms to move the robot from a present lateral offset and following distance (e.g., zero lateral offset and the standard following distance) toward having a duck lateral offset 331 and a duck following distance 332. As shown in the example of FIG. 4, the duck's lateral offset 331 and following distance 332 are 162.3 mm and 154(x)+54 mm, respectively. The cross's lateral offset 333 and following distance 334 are 277.6 mm and −50.6 mm respectively. In various embodiments, the lateral offsets and/or following distances may vary depending on one or more factors.

After the avoidance protocol has been triggered, the robot will determine when to return to normal following mode. The moment when the robot determines to return to normal following mode is referred to herein as the return trigger moment. In some embodiments, determining whether to return to normal following is different for a cross versus a duck. The robot can determine an obstacle navigation return factor. The obstacle navigation factor for a duck 327 is 1.0-0.15 (x) and the obstacle navigation factor for a cross 328 is 0.68. The “x” may, for example, be the convergence velocity at the time the return trigger moment. In another example, the “x” may be an average convergence velocity over a time or an expected convergence velocity at a particular time.

As the robot performs the duck 325 or the cross 326, the collision time 306 is compared at stage 335 to the return factor. If the collision time 306 is above the return factor (the return factor is less than the collision time 306), then the robot will return 340 to normal operation (e.g., zero lateral offset relative to the trajectory of the leader and following at the standard following distance). In practice, this will cause the robot to return to normal operation based on the obstacle 301 having been successfully evaded (and no longer posing an imminent threat of collision). If the collision time 306 is not above (equal to or below) the return factor (the return factor is not less than the collision time), then the robot will continue the duck 325 or the cross 326 as in accordance with guidance box 330. During the return, the robot will move toward having a lateral offset of about 0 mm (e.g., 0 mm+/−10 mm), or other standard lateral offset, and a normal following distance 341. In some embodiments, returning to the standard lateral offset is expected to take about 1.2 seconds. If it is determined 342 that after 1.2 seconds, the robot is not at standard lateral offset and normal following distance 341, then the return process 340 will continue until the robot is at the standard lateral offset and standard following distance. The robot may not have returned to standard following behavior for one or more reasons, e.g., due to a secondary obstacle being present and of imminent collision potential, or other delay in the return process. In response to the robot having returned to standard following, the behavior ends at stage 350.

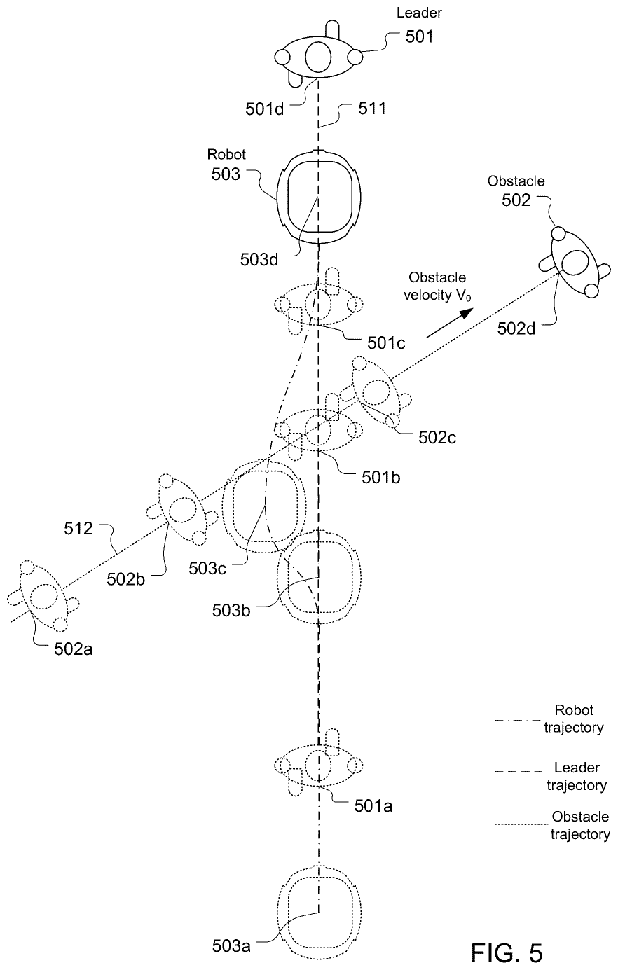

FIG. 5 is a diagram showing an obstacle 502 moving in a non-perpendicular trajectory relative to a trajectory 511 of a leader 501 in accordance with the invention. A robot 503 has performed a duck, e.g., because the obstacle decision factor was below a threshold. The path of the robot 503 is shown to have performed a duck, leaving the trajectory 511 of the leader 501 substantially transverse to a trajectory 512 of the obstacle 502. In the example of FIG. 5, at a time T₁ the obstacle 502 is at position 502a, the robot 503 is at a position 503a, and the leader is at a position 501a. As the robot 503, the leader 501, and the obstacle 502 each progress along their respective trajectory, at a time T₂ they are at positions 503b, 501b, and 502b, respectively. Based on the velocity of the obstacle 502, velocity of the leader 501, following distance, and other factors, at time T₂ the collision time was determined to be under a threshold collision time, e.g., 1.25 seconds. Therefore, an avoidance protocol was triggered by the robot 503. In this example, when the avoidance protocol was triggered, the following distance was 900 mm. The obstacle avoidance decision factor was calculated to be above the 0.60 threshold (e.g., to be 0.98), and therefore a duck protocol was triggered at stage 324.

In FIG. 5, at a time T₃, the obstacle 502 is at position 502c, the robot 503 is at a (collision avoidance) position 503c, and the leader 501 is at a position 501c. At time T₃, the collision time is determined to be above .86 s and increasing. Therefore, the robot 503 begins returning to a normal following protocol. At time T₃ the robot 503 is at a maximum lateral offset that the robot 503 reaches in this example (although the robot 503 may reach different lateral offsets in different collision avoidance scenarios), as the return trigger is reached to initiate the robot 503 returning to normal following and thus to a standard (e.g., 0 mm) offset and thus back in line with a trajectory of the leader 501. In the example of FIG. 5, this max offset is −162 mm. At a time T₄, the robot 503 has completed the evasive action and is returning to a standard following position 503d behind the leader's position 501d, and the obstacle 502 is at a position 502d, and has been successfully avoided.

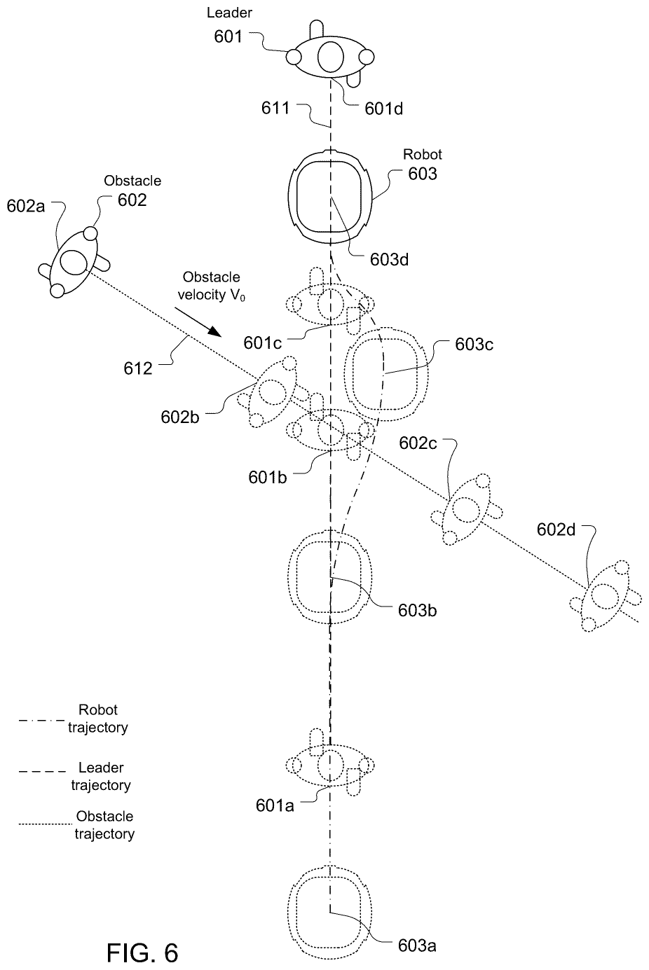

FIG. 6 is a diagram showing an obstacle 602 moving in a trajectory 612 non-perpendicular relative to the leader's 601 path 611 in accordance with the invention. As shown in FIG. 6, at four sequential times, the leader 601 is at positions 601a, 601b, 601c, 601d, the obstacle 602 is at positions 602a, 602b, 602c, 602d, and the robot 603 is at positions 603a, 603b, 603c, 603d. In FIG. 6, a robot 603 performs a cross because the obstacle decision factor was above a threshold (e.g., 0.6). To perform the cross, the robot 603 moves out of the trajectory 611 of the leader 601 substantially transverse to the trajectory 612 of the obstacle 602. During the cross, the robot 603 shortens the following distance behind the leader 601 to pass in front of the obstacle 602 with a comfortable amount of clearance. When returning to standard following position after performing a cross, the robot 603 slows down to allow the leader 601 to get further ahead. In some embodiments, due to the lateral offset, the robot 603 may still move at the same speed when returning after a cross and while following at the standard following distance.

If the robot 603 were to perform a duck, the robot 603 would increase the following distance, allowing the obstacle 602 to pass in front. When the duck is completed the robot 603 will speed up to return to the standard following position.

Due to the angle of approach of the path 612 of the obstacle 602, the convergence velocity is significantly higher than in the example of FIG. 5. In different examples, the leader 601 or the obstacle 602 are moving faster or slower causing variances in the convergence velocity other than just angle of approach. Due to the convergence velocity being higher, the lateral offset of the robot's cross is higher than if the velocity was slower.

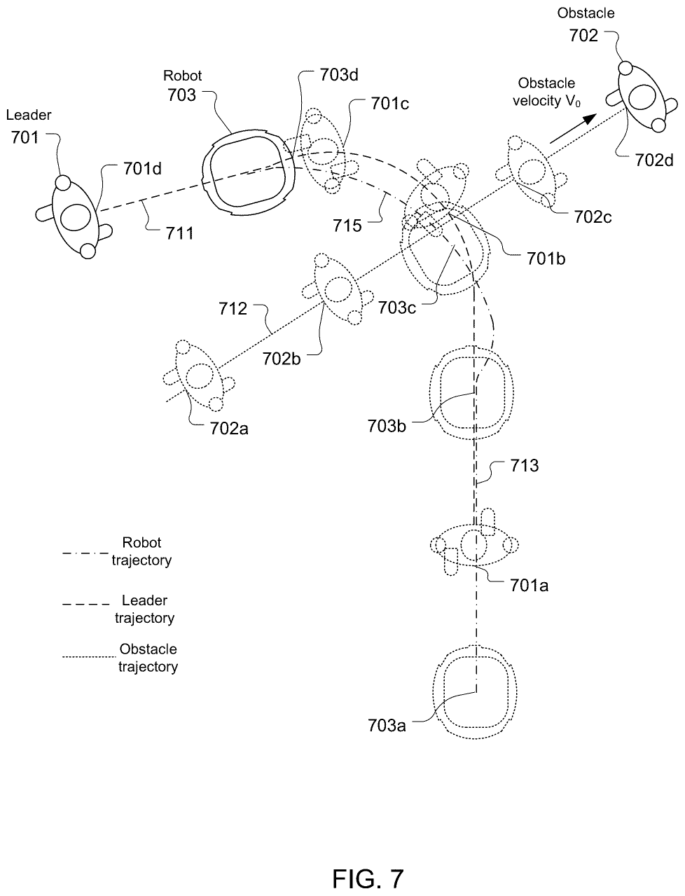

FIG. 7 is a diagram showing robot 703 following a leader 701 having a curved trajectory 711, and the robot 703 avoiding an obstacle 702 on a trajectory 712 that intersects the leader's trajectory 711 in accordance with the invention. As shown in FIG. 7, at four sequential times, the leader 701 is at positions 701a, 701b, 701c, 701d, the obstacle 702 is at positions 702a, 702b, 702c, 702d, and the robot 703 is at positions 703a, 703b, 703c, 703d. Also as shown in FIG. 7, because of the curved trajectory 711, the robot's standard following path 713 is different from the curved trajectory 711. In this example, the lateral offset of the duck is measured from the standard following path 713 and not from the curved trajectory 711. This results in the robot 703 moving along a ducked trajectory 715. In other examples of the leader 701 having a curved trajectory, the robot 703 follows the trajectory of the leader directly, and thus the lateral offset is calculated from the leader's trajectory 711.

In the example of FIG. 7, the following distance is determined along the robot standard path 713 and the available space is calculated directly from the robot 703 to the leader 701. In FIG. 7, using the available space to the leader 701 allows a preferable decision factor to be calculated because the convergence velocity will be calculated based on the robot's projected path.

What is claimed is:

1. A method of operating a robot, configured to follow, in a standard trajectory of the robot, a trajectory of a leader, in a manner to avoid an obstacle, the obstacle having a trajectory that intersects with the standard trajectory of the robot, the method comprising:
detecting the obstacle using a set of sensors of the robot;
determining, by a controller of the robot coupled to the set of sensors, using data from the set of sensors, a set of parameters characterizing motion of the obstacle relative to the robot;
evaluating, by the controller, a risk of a collision between the obstacle and the robot;
under a circumstance wherein the evaluated risk exceeds a predetermined threshold, causing, by the controller, implementation of an obstacle avoidance protocol; and
after implementation of the obstacle avoidance protocol, causing, by the controller, the robot to return to following the trajectory of the leader.

2. The method of claim 1, wherein the obstacle avoidance protocol includes causing the robot to have a lateral offset from the standard trajectory.

3. The method of claim 2, wherein the obstacle avoidance protocol is selected from the group consisting of a cross and a duck.

4. The method of claim 1, wherein evaluating risk of a collision includes evaluating a collision time and wherein the predetermined threshold is a value of the collision time.

5. The method of claim 4, wherein implementation of the obstacle avoidance protocol is deemed completed based on the collision time being above a return threshold.

6. The method of claim 5, wherein the obstacle avoidance protocol is selected from the group consisting of a cross and a duck, and wherein implementation of the duck is deemed completed based on the collision time being above a duck return threshold of the duck and implementation of the cross is deemed completed based on the collision time being above a cross return threshold that is different from the duck return threshold.

7. The method of claim 1, further comprising:
evaluating, by the controller, (i) a convergence speed of the obstacle and the robot and (ii) a distance of the robot from the leader; and
calculating an obstacle navigation decision factor based on the convergence speed and the distance.

8. The method of claim 7, wherein the obstacle navigation decision factor is compared to a decision threshold to determine a type of obstacle avoidance protocol to be implemented by the robot.

9. The method of claim 8, wherein the type of obstacle avoidance protocol is selected from the group consisting of a cross and a duck.

10. The method of claim 1, wherein the robot performs the method autonomously.

11. A robot configured to follow a trajectory of a leader in a manner to avoid an obstacle, comprising:
a body including a set of sensors and a drive mechanism;
a controller disposed in the body and coupled to the set of sensors and the drive mechanism;
wherein the controller is configured to:
detect the obstacle using the set of sensors;
determine, using data from the set of sensors, a set of parameters characterizing motion of the obstacle relative to the robot;
evaluate a risk of a collision between the obstacle and the robot;
cause, under a circumstance wherein the evaluated risk exceeds a predetermined threshold, implementation of an obstacle avoidance protocol; and
cause, after implementation of the obstacle avoidance protocol, the robot to return to following the trajectory of the leader.

12. The robot of claim 11, wherein to cause implementation of the obstacle avoidance protocol the controller is configured to cause the robot to have a lateral offset from the trajectory of the leader.

13. The robot of claim 12, wherein the obstacle avoidance protocol is selected from the group consisting of a cross and a duck.

14. The robot of claim 11, wherein to evaluate the risk of a collision the controller is configured to evaluate a collision time and wherein the predetermined threshold is a value of the collision time.

15. The robot of claim 14, wherein the controller is configured to determine that implementation of the obstacle avoidance protocol is complete based on the collision time being above a return threshold.

16. The robot of claim 15, wherein the obstacle avoidance protocol is selected from the group consisting of a cross and a duck, and wherein the controller is configured to determine that implementation of the duck is complete based on the collision time being above a duck return threshold of the duck and to determine that implementation of the cross is complete based on the collision time being above a cross return threshold that is different from the duck return threshold.

17. The robot of claim 11, wherein the controller is further configured to:
evaluate (i) a convergence speed of the obstacle and the robot and (ii) a distance from the leader; and
calculate an obstacle navigation decision factor based on the convergence speed and the distance.

18. The robot of claim 17, wherein the controller is configured to compare the obstacle navigation decision factor to a decision threshold to determine a type of obstacle avoidance protocol to be implemented by the robot.

19. The robot of claim 18, wherein the type of obstacle avoidance protocol is selected from the group consisting of a cross and a duck.
